(19) United States
(12) Patent Application Publication
(10) Pub. No.: US 2026/0040214 A1
(43) Pub. Date: Feb. 5, 2026

(54) WAKE-UP SIGNAL BASED CONTROL RESOURCE SET ADAPTATION AND DATA CHANNEL RATE MATCHING

(71) Applicant: QUALCOMM Incorporated, San Diego, CA (US)

(72) Inventors: Weimin DUAN, San Diego, CA (US); Jing JIANG, San Diego, CA (US); Jing SUN, San Diego, CA (US); Gabi SARKIS, San Diego, CA (US)

(21) Appl. No.: 18/790,665

(22) Filed: Jul. 31, 2024

(51) Int. Cl. H04W 52/02

(52) U.S. Cl. CPC H04W 52/0229

(57) ABSTRACT

Methods, systems, and devices for wireless communications are described. A network entity may provide an indication of which parts of a control resource set (CORESET) may be utilized for control information, and which parts may be utilized for data transmissions. For example, a network entity may communicate configuration information indicating multiple parts of a CORESET resource set to a user equipment (UE), along with an indication to monitor for a wake-up signal (WUS). During a wakeup occasion, the network entity may transmit a WUS to the UE. The WUS may indicate to the UE whether one or more of the parts of the CORESET may be active and may thus be utilized for the communication of control information. In response to receiving the WUS, the UE may monitor for a transmission of control information, data information, or a combination thereof, from the network entity.

### FIELD OF TECHNOLOGY

The following relates to wireless communications, including wake-up signal (WUS) based control resource set (CORESET) adaptation and physical downlink shared channel (PDSCH) rate matching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, a network node, such as a base station, may configure periodic control resources (e.g., control resource set (CORESET) resources) that may be used to transmit control information to a UE. In some cases, a quantity of UEs may be configured to monitor a set of search spaces that are located within the control resources, such as common search spaces or UE-specific search spaces, for control information (e.g., in a physical downlink control channel (PDCCH)).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, configuration information indicating a set of multiple parts of a control resource set and indicating to monitor a wakeup occasion for a wake-up signal, the wakeup occasion occurring prior to the control resource set, receiving, during the wakeup occasion and based on the configuration information, the wake-up signal indicating whether one or more control resource set parts of the set of multiple parts of the control resource set is active, and monitoring, or skip monitoring of, the one or more control resource set parts of the control resource set based on the configuration information and the wake-up signal.

A UE for wireless communications is described. The UE may include one or more memories storing processor executable code, and one or more processors coupled with the one or more memories. The one or more processors may individually or collectively be operable to execute the code to cause the UE to receive, from a network entity, configuration information indicating a set of multiple parts of a control resource set and indicating to monitor a wakeup occasion for a wake-up signal, the wakeup occasion occurring prior to the control resource set, receive, during the wakeup occasion and based on the configuration information, the wake-up signal indicating whether one or more control resource set parts of the set of multiple parts of the control resource set is active, and monitor, or skip monitoring of, the one or more control resource set parts of the control resource set based on the configuration information and the wake-up signal.

Another UE for wireless communications is described. The UE may include means for receiving, from a network entity, configuration information indicating a set of multiple parts of a control resource set and indicating to monitor a wakeup occasion for a wake-up signal, the wakeup occasion occurring prior to the control resource set, means for receiving, during the wakeup occasion and based on the configuration information, the wake-up signal indicating whether one or more control resource set parts of the set of multiple parts of the control resource set is active, and means for monitoring, or skip monitoring of, the one or more control resource set parts of the control resource set based on the configuration information and the wake-up signal.

A non-transitory computer-readable medium storing code for wireless communications is described. The code may include instructions executable by one or more processors to receive, from a network entity, configuration information indicating a set of multiple parts of a control resource set and indicating to monitor a wakeup occasion for a wake-up signal, the wakeup occasion occurring prior to the control resource set, receive, during the wakeup occasion and based on the configuration information, the wake-up signal indicating whether one or more control resource set parts of the set of multiple parts of the control resource set is active, and monitor, or skip monitoring of, the one or more control resource set parts of the control resource set based on the configuration information and the wake-up signal.

Some examples of the method, UEs, and non-transitory computer-readable medium described herein may further include operations, features, means, or instructions for monitoring for data transmission within the one or more control resource set parts of the set of multiple parts of the control resource set based on the wake-up signal indicating the one or more control resource set parts of the set of multiple parts of the control resource set to be inactive.

In some examples of the method, UEs, and non-transitory computer-readable medium described herein, receiving the wake-up signal may include operations, features, means, or instructions for receiving the wake-up signal including one or more bits indicating whether the one or more control resource set parts of the set of multiple parts of the control resource set may be active.

Some examples of the method, UEs, and non-transitory computer-readable medium described herein may further include operations, features, means, or instructions for receiving, via a first control resource set part of the set of multiple parts of the control resource set and based on the wake-up signal, downlink control information indicating whether the one or more control resource set parts of the set of multiple parts of the control resource set may be active.

Some examples of the method, UEs, and non-transitory computer-readable medium described herein may further include operations, features, means, or instructions for receiving, via a first control resource set part of the set of multiple parts of the control resource set and based on the wake-up signal, one or more cyclic redundancy check bits indicating whether the one or more control resource set parts of the set of multiple parts of the control resource set may be active.

Some examples of the method, UEs, and non-transitory computer-readable medium described herein may further include operations, features, means, or instructions for receiving, via a first control resource set part of the set of multiple parts of the control resource set and based on the wake-up signal, a downlink control information including a bit indicating activation of the one or more control resource set parts of the control resource set.

Some examples of the method, UEs, and non-transitory computer-readable medium described herein may further include operations, features, means, or instructions for receiving the wake-up signal including a radio network temporary identifier (RNTI), the RNTI indicating whether the one or more control resource set parts of the control resource set includes a grant for a downlink transmission or control information other than a downlink transmission grant.

In some examples of the method, UEs, and non-transitory computer-readable medium described herein, presence or absence of a RNTI in the wake-up signal indicates whether the one or more control resource set parts of the control resource set includes a grant for a downlink transmission or control information other than a downlink transmission grant.

In some examples of the method, UEs, and non-transitory computer-readable medium described herein, the wake-up signal may be a physical downlink control channel (PDCCH) transmission, a sequence-based wake-up signal, or a low power wake-up signal.

In some examples of the method, UEs, and non-transitory computer-readable medium described herein, the monitoring may be skipped based on the wake-up signal indicating that none of the set of multiple parts of the control resource set may be active.

In some examples of the method, UEs, and non-transitory computer-readable medium described herein, the monitoring may be performed based on the wake-up signal indicating that at least one of the set of multiple parts of the control resource set may be active.

A method for wireless communications by a network entity is described. The method may include transmitting, to a UE, configuration information indicating a set of multiple parts of a control resource set and indicating to monitor a wakeup occasion for a wake-up signal, the wakeup occasion occurring prior to the control resource set, transmitting, during the wakeup occasion and based on the configuration information, the wake-up signal indicating that one or more control resource set parts of the set of multiple parts of the control resource set is active, and transmitting, to the UE, at least one control message via the one or more control resource set parts of the control resource set based on the configuration information and the wake-up signal.

A network entity for wireless communications is described. The network entity may include one or more memories storing processor executable code, and one or more processors coupled with the one or more memories. The one or more processors may individually or collectively be operable to execute the code to cause the network entity to transmit, to a UE, configuration information indicating a set of multiple parts of a control resource set and indicating to monitor a wakeup occasion for a wake-up signal, the wakeup occasion occurring prior to the control resource set, transmit, during the wakeup occasion and based on the configuration information, the wake-up signal indicating that one or more control resource set parts of the set of multiple parts of the control resource set is active, and transmit, to the UE, at least one control message via the one or more control resource set parts of the control resource set based on the configuration information and the wake-up signal.

Another network entity for wireless communications is described. The network entity may include means for transmitting, to a UE, configuration information indicating a set of multiple parts of a control resource set and indicating to monitor a wakeup occasion for a wake-up signal, the wakeup occasion occurring prior to the control resource set, means for transmitting, during the wakeup occasion and based on the configuration information, the wake-up signal indicating that one or more control resource set parts of the set of multiple parts of the control resource set is active, and means for transmitting, to the UE, at least one control message via the one or more control resource set parts of the control resource set based on the configuration information and the wake-up signal.

A non-transitory computer-readable medium storing code for wireless communications is described. The code may include instructions executable by one or more processors to transmit, to a UE, configuration information indicating a set of multiple parts of a control resource set and indicating to monitor a wakeup occasion for a wake-up signal, the wakeup occasion occurring prior to the control resource set, transmit, during the wakeup occasion and based on the configuration information, the wake-up signal indicating that one or more control resource set parts of the set of multiple parts of the control resource set is active, and transmit, to the UE, at least one control message via the one or more control resource set parts of the control resource set based on the configuration information and the wake-up signal.

In some examples of the method, network entities, and non-transitory computer-readable medium described herein, transmitting the wake-up signal may include operations, features, means, or instructions for transmitting the wake-up signal including one or more bits indicating which of the set of multiple parts of the control resource set may be active.

Some examples of the method, network entities, and non-transitory computer-readable medium described herein may further include operations, features, means, or instructions for transmitting, via a first control resource set part of the set of multiple parts of the control resource set and based on the wake-up signal, downlink control information indicating which of the set of multiple parts of the control resource set may be active.

Some examples of the method, network entities, and non-transitory computer-readable medium described herein may further include operations, features, means, or instructions for transmitting, via a first control resource set part of the set of multiple parts of the control resource set and based on the wake-up signal, one or more cyclic redundancy check bits indicating which of the set of multiple parts of the control resource set may be active.

Some examples of the method, network entities, and non-transitory computer-readable medium described herein may further include operations, features, means, or instructions for transmitting, via a first control resource set part of the set of multiple parts of the control resource set and based on the wake-up signal, a downlink control information including a bit indicating activation of the one or more control resource set parts of the control resource set.

Some examples of the method, network entities, and non-transitory computer-readable medium described herein may further include operations, features, means, or instructions for receiving the wake-up signal including a RNTI, the RNTI indicating whether the one or more control resource set parts of the control resource set includes a grant for a downlink transmission or control information other than a downlink transmission grant.

In some examples of the method, network entities, and non-transitory computer-readable medium described herein, presence or absence of an RNTI in the wake-up signal indicates whether the one or more control resource set parts of the control resource set includes a grant for a downlink transmission or control information other than a downlink transmission grant.

In some examples of the method, network entities, and non-transitory computer-readable medium described herein, the wake-up signal may be a PDCCH transmission, a sequence-based wake-up signal, or a low power wake-up signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support wake-up signal (WUS) based control resource set (CORESET) adaptation and physical downlink shared channel (PDSCH) rate matching in accordance with one or more aspects of the present disclosure.

FIGS. 3 and 4 show examples of CORESET resource configurations that support WUS based CORESET adaptation and PDSCH rate matching in accordance with one or more aspects of the present disclosure.

FIG. 5 shows an example of a process flow that supports WUS based CORESET adaptation and PDSCH rate matching in accordance with one or more aspects of the present disclosure.

FIGS. 6 and 7 show block diagrams of devices that support WUS based CORESET adaptation and PDSCH rate matching in accordance with one or more aspects of the present disclosure.

FIG. 8 shows a block diagram of a communications manager that supports WUS based CORESET adaptation and PDSCH rate matching in accordance with one or more aspects of the present disclosure.

FIG. 9 shows a diagram of a system including a device that supports WUS based CORESET adaptation and PDSCH rate matching in accordance with one or more aspects of the present disclosure.

FIGS. 10 and 11 show block diagrams of devices that support WUS based CORESET adaptation and PDSCH rate matching in accordance with one or more aspects of the present disclosure.

FIG. 12 shows a block diagram of a communications manager that supports WUS based CORESET adaptation and PDSCH rate matching in accordance with one or more aspects of the present disclosure.

FIG. 13 shows a diagram of a system including a device that supports WUS based CORESET adaptation and PDSCH rate matching in accordance with one or more aspects of the present disclosure.

FIGS. 14 and 15 show flowcharts illustrating methods that support WUS based CORESET adaptation and PDSCH rate matching in accordance with one or more aspects of the present disclosure.

### DETAILED DESCRIPTION

In some cases, a network node, such as a base station, may configure periodic control resources (e.g., control resource set (CORESET) resources) that may be used to transmit control information to a user equipment (UE). In some cases, a quantity of UEs may be configured to monitor a set of search spaces that are located within the control resources, such as common search spaces or UE-specific search spaces, for control information (e.g., in a physical downlink control channel (PDCCH)). In some cases, less than all of the control resources may be occupied by control information. Further, in some cases, a data transmission (e.g., a physical downlink shared channel (PDSCH) transmission) to the UE may be scheduled in a same time period (e.g., within a same slot) as an instance of the control resources. In such cases rate-matching may be used to help facilitate utilization of all or a portion of the control resources that are not occupied by control information for data transmission. However, channel capacity may be limited by available resources, which may inhibit efficiency of CORESET resources.

To enhance PDSCH rate matching around CORESET resources, a network entity may provide an indication of which parts of a CORESET may be utilized for control information, and which parts may be utilized for data transmissions. For example, a network entity may communicate configuration information indicating multiple parts of a CORESET resource set to a UE, along with an indication to monitor for a wake-up signal (WUS). During a wakeup occasion, the network entity may transmit a WUS to the UE. The WUS may indicate to the UE whether one or more of the parts of the CORESET may be active and may thus be utilized for the communication of control information. In response to receiving the WUS, the UE may monitor for a transmission of control information, data information, or a combination thereof, from the network entity.

Aspects of the disclosure are initially described in the context of wireless communications systems. Aspects of the disclosure are further described in the context of CORESET resource configurations and process flows. Aspects of the disclosure are further illustrated by and described with reference to apparatus diagrams, system diagrams, and flowcharts that relate to WUS based CORESET adaptation and PDSCH rate matching.

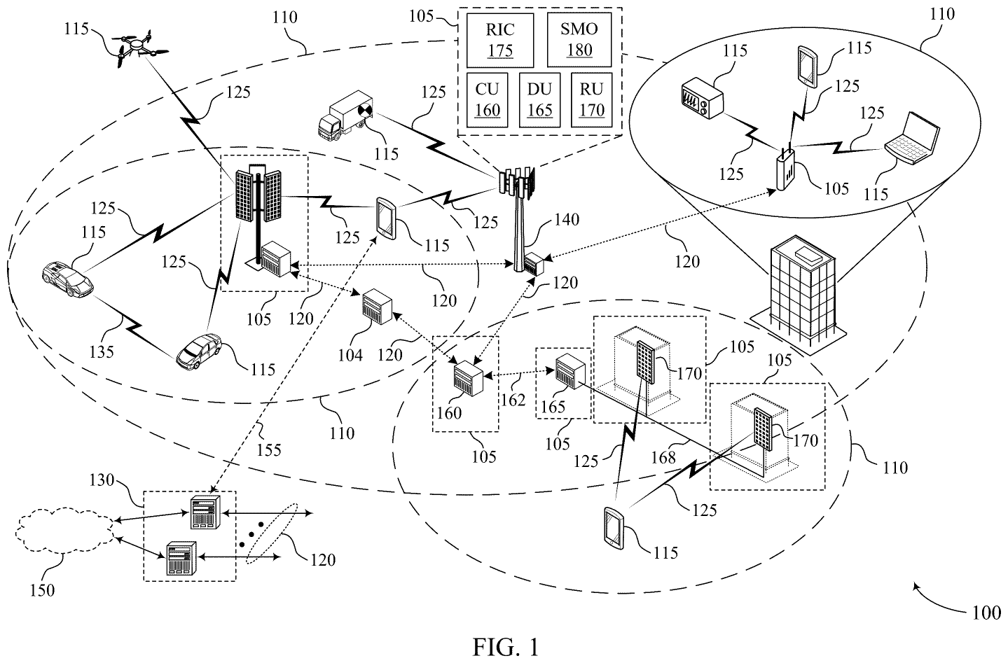

FIG. 1 shows an example of a wireless communications system 100 that supports WUS based CORESET adaptation and PDSCH rate matching in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases the network entity 105 may configure periodic control resources (e.g., CORESET resources) that may be used to transmit control information to the UE 115. In some cases, a quantity of UEs 115 may be configured to monitor a set of search spaces that are located within the control resources, such as common search spaces or UE-specific search spaces, for control information (e.g., in a PDCCH). In some cases, less than all of the control resources may be occupied by control information. Further, in some cases, a data transmission (e.g., a PDSCH transmission) to the UE 115 may be scheduled in a same time period (e.g., within a same slot) as an instance of the control resources. In such cases rate-matching may be used to help facilitate utilization of all or a portion of the control resources that are not occupied by control information for the data transmission. However, channel capacity may be limited by available resources, which may inhibit efficiency of CORESET resources.

To enhance PDSCH rate matching around CORESET resources, the network entity 105 may provide an indication of which parts of a CORESET may be utilized for control information, and which parts may be utilized for data transmissions. For example, the network entity 105 may communicate configuration information indicating multiple parts of a CORESET resource set to a UE 115, along with an indication to monitor for a WUS. During a wakeup occasion, the network entity 105 may transmit a WUS to the UE 115. The WUS may indicate to the UE 115 whether one or more of the parts of the CORESET may be active and may thus be utilized for the communication of control information. In response to receiving the WUS, the UE 115 may monitor for a transmission of control information, data information, or a combination thereof, from the network entity 105.

Techniques of the present disclosure may increase reliability and efficiency within the wireless communications system 100 by enabling a UE 115 to determine which parts of a set of CORESET resources may be active (e.g., associated with the transmission of control data). Techniques described herein may improve communications between the network entity 105 and the UE 115 by enabling the network entity 105 to communicate with the UE 115 whether the UE 115 may monitor or skip monitoring an associated PDCCH for various data, and by reusing the WUS resources. Additionally, a WUS-based CORESET resource adaptation may be detected in various lower power modes (e.g., software defined radio (SDR), low-power wake up radio (LP-WUR)). As such, techniques described herein may enable more efficient utilization of communication resources, improved communication reliability, decreased power consumption, reduced complexity, data rate enhancement, and improved operation efficiency of the UE 115.

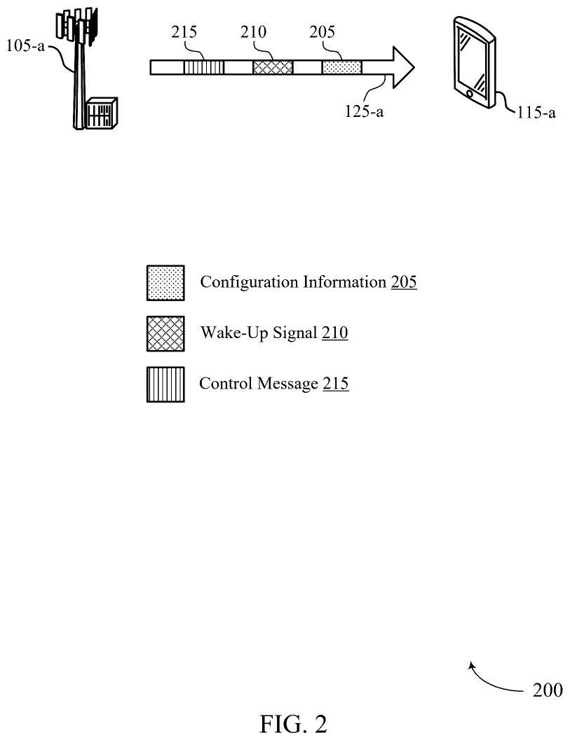

FIG. 2 shows an example of a wireless communications system 200 that supports WUS based CORESET adaptation and PDSCH rate matching in accordance with one or more aspects of the present disclosure. Aspects of the wireless communications system 200 may implement, or be implemented by, aspects of the wireless communications system 100. For example, the wireless communications system 200 illustrates signaling and various configurations that enable the use of WUS to dynamically indicate usage of one or more parts of a set of CORESET resources in transmissions. The wireless communications system 200 may include a network entity 105-a, a UE 115-a, and a communication link 125-a, which may be examples of a network entity 105, a UE 115, and a communication link 125, as described with reference to FIG. 1.

In some cases, the network entity 105-a may configure periodic control resources (e.g., CORESET resources) that may be used to transmit control information to the UE 115-a. Additionally, the UE 115-a may be configured to monitor a set of search spaces that are located within the control resources, such as common search spaces or UE-specific search spaces, for control information (e.g., in a PDCCH). For example, according to some LTE schemes, the network entity 105-a may transmit a control format indicator (CFI) to an associated UE 115-a during initial communications. The CFI may indicate to the UE 115-a a quantity of OFDM symbols that may be used in transmitting via one or more control channels (e.g., PDCCH, PHICH) at each subframe, as less than all of the control resources may be occupied by control information. For example, in the case that the CFI may be set to be “1” for a subframe, one symbol (e.g., a first symbol) at the subframe may be used for PDCCH allocation. In the case that the CFI is “2,” two symbols (e.g., the first symbol and a second symbol) may be used for PDCCH allocation. However, the use of the CFI indicator may restrict or limit dynamic resource multiplexing across data channels and control resources. Additionally, the CFI indicator may dictate the monitoring of the control channels, which may cause reliability issues in the wireless communications system 200. Further, in some cases, a data transmission (e.g., a PDSCH transmission) to the UE 115-a may be scheduled in a same time period (e.g., within a same slot) as an instance of the control resources.

Rate-matching may be used to help facilitate utilization of all or a portion of the control resources that are not occupied by control information for data transmission. However, channel capacity may be limited by available resources. For example, a set of CORESET resources may be occupied by PDCCH transmissions sent to other UEs 115 or it may be available for PDSCH transmissions for the UE 115-a. While the UE 115-a may prioritize PDSCH rate matching (e.g., around a PDCCH transmission granting the PDSCH transmissions), the UE 115-a may not be aware of PDCCH transmissions sent to the other UEs 115. In some examples, to improve the efficiency of CORESET resources and increase overall efficiency in transmission, the UE 115-a may use unoccupied (e.g., unused, extra) CORESET resources for PDSCH transmissions. For example, the network entity 105-a may indicate to the UE 115-a whether various CORESET resources may be used in PDSCH transmissions or not. However, previously techniques used in this indication may result in over-rate-matching, which may cause unnecessary overhead and inefficiencies in communications.

To enhance PDSCH rate matching around CORESET resources, the network entity 105-a may provide an indication of which parts of a CORESET may be utilized for control information, and which parts may be utilized for data transmissions. For example, the network entity 105-a may communicate configuration information 205 indicating multiple parts of a CORESET resource set to a UE 115-a, along with an indication to monitor a wakeup occasion for a WUS 210. During the wakeup occasion, the network entity 105-a may transmit the WUS 210 to the UE 115-a. The WUS 210 may indicate to the UE 115-a whether one or more of the parts of the CORESET may be active and may thus be utilized for the communication of a control message 215 which may include control information. In response to receiving the WUS 210, the UE 115-a may monitor for the control message 215, data information, or a combination thereof, from the network entity 105-a. Communicating which parts of the CORESET may be used in PDSCH transmissions may enable more efficient utilization of communication resources, improved communication reliability between the network entity 105-a and the UE 115-a, and improved operation efficiency of the UE 115.

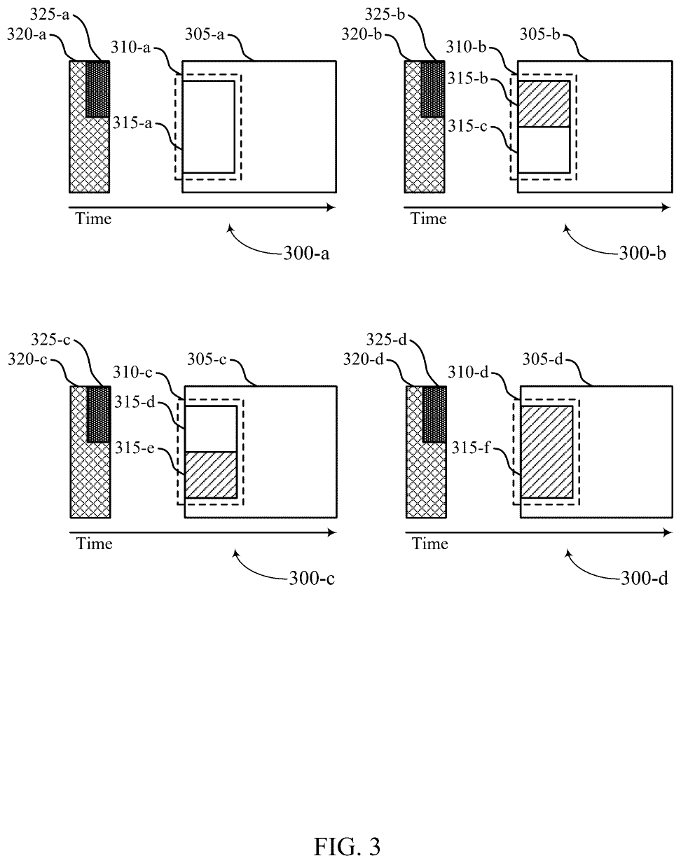

FIG. 3 shows examples of CORESET resource configurations 300 that support WUS based CORESET adaptation and PDSCH rate matching in accordance with one or more aspects of the present disclosure. Aspects of the CORESET resource configurations 300 may implement, or be implemented by, aspects of the wireless communications system 100 or the wireless communications system 200. For example, the CORESET resource configurations 300 illustrate various configurations that enable the use of a WUS to dynamically indicate utilization of one or more parts of a set of CORESET resources in transmissions. Each of the CORESET resource configurations 300 may illustrate PDSCH resources 305, a CORESET 310, a wakeup occasion 320, and a WUS 325 in time, as described further with reference to FIGS. 1 and 2. In some examples, the duration (e.g., in time) of the PDSCH resources 305 may correspond to a TTI, a slot, a subslot, or the like. For example, a TTI may include one or more PDCCH transmissions in one or more parts 315 of a CORESET 310, as well as a PDSCH resource 350 transmission that may be rate matched around the entirety of the CORESET 310 or around one or more parts 315 of the CORESET 310.

A network entity may provide an indication (e.g., to a UE) of which parts 315 of the CORESET 310 may be utilized for control information, and which parts may be utilized for data transmissions. For example, the network entity may communicate configuration information indicating the one or more parts 315 of a CORESET 310 to a UE, along with an indication to monitor a wakeup occasion 320 (e.g., a time-frequency resource) for a WUS 325. In some examples, each CORESET 310 may include two parts 315 while, in other examples, each CORESET 310 may include another quantity of parts 315. During a wakeup occasion 320, the network entity may transmit a WUS 325 to the UE. The WUS 325 may indicate to the UE whether one or more of the parts 315 of the CORESET 310 may be active and may thus be utilized for the communication of control information. In response to receiving the WUS 325, the UE may monitor for a transmission of control information, data information, or a combination thereof via the PDSCH resources 305 from the network entity.

In the example of CORESET resource configuration 300-a, the parts 315-a of the CORESET 310-a may be inactive. For example, during the wakeup occasion 320-a, the network entity may transmit and the UE may receive a WUS 325-a indicating that all of the parts 315-a of the CORESET 310-a may be inactive. In some examples, the WUS 325-a may indicate the status of the parts 315-a via a value, such as “0,” which may indicate to the UE that both of the parts 315-a of the CORESET 310-a may be inactive. In response to the WUS 325-a indicating the parts 315-a of the CORESET 310-a to be inactive, the UE may skip monitoring the associated PDCCH resources for control information (e.g., as there is no PDCCH transmission in the CORESET 310-a) and may instead monitor both the PDSCH resources 305-a and the parts 315-a of the CORESET 310-a for data transmission.

In the example of CORESET resource configuration 300-b, a part 315-b of the CORESET 310-b may be active, while a part 315-c of the CORESET 310-b may be inactive. For example, during the wakeup occasion 320-b, the network entity may transmit and the UE may receive a WUS 325-b indicating that the part 315-b of the CORESET 310-b may be active while the part 315-c of the CORESET 310-b may be inactive. In some examples, the WUS 325-b may indicate the status of the part 315-b and the part 315-c via a value, such as “1,” which may indicate to the UE that a first part of the CORESET 310-b may be active. In response to the WUS 325-b indicating the part 315-b of to be active and the part 315-c to be inactive, the UE may monitor PDCCH resources associated with the part 315-b and may skip monitoring PDCCH resources associated with the part 315-c for control information (e.g., as there is no PDCCH transmission in the part 315-c). The UE may instead monitor both the PDSCH resources 305-b and the part 315-c of the CORESET 310-b for data transmission.

In the example of CORESET resource configuration 300-c, a part 315-d of the CORESET 310-c may be inactive, while a part 315-e of the CORESET 310-c may be active. For example, during the wakeup occasion 320-c, the network entity may transmit and the UE may receive a WUS 325-c indicating that the part 315-d of the CORESET 310-c may be inactive while the part 315-e of the CORESET 310-c may be active. In some examples, the WUS 325-c may indicate the status of the part 315-d and the part 315-e via a value, such as “2,” which may indicate to the UE that a second part of the CORESET 310-c may be active. In response to the WUS 325-c indicating the part 315-d of to be inactive and the part 315-e to be active, the UE may monitor PDCCH resources associated with the part 315-e and may skip monitoring PDCCH resources associated with the part 315-d for control information (e.g., as there is no PDCCH transmission in the part 315-d). The UE may instead monitor both the PDSCH resources 305-c and the part 315-d of the CORESET 310-c for data transmission.

In the example of CORESET resource configuration 300-d, the parts 315-f of the CORESET 310-d may be active. For example, during the wakeup occasion 320-d, the network entity may transmit and the UE may receive a WUS 325-d indicating that the parts 315-f of the CORESET 310-d may be active. In some examples, the WUS 325-d may indicate the status of the parts 315-f via a value, such as “4,” which may indicate to the UE that both of the parts 315-f of the CORESET 310-d may be active. In response to the WUS 325-d indicating the parts 315-f of the CORESET 310-d to be active, the UE may monitor the associated PDCCH resources for control information (e.g., as there may be a PDCCH transmission in the CORESET 310-d) and the PDSCH resources 305-d for data transmission.

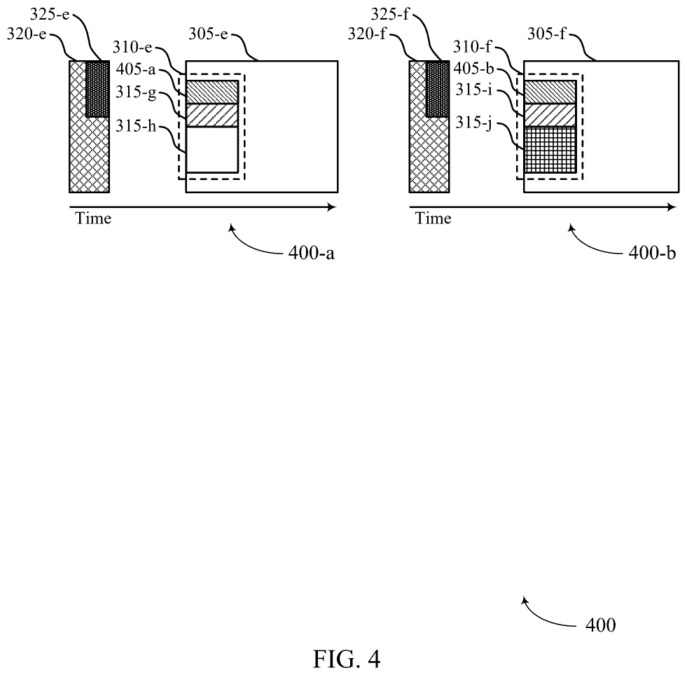

FIG. 4 shows examples of CORESET resource configurations 400 that support WUS based CORESET adaptation and PDSCH rate matching in accordance with one or more aspects of the present disclosure. Aspects of the CORESET resource configurations 400 may implement, or be implemented by, aspects of the wireless communications system 100 or the wireless communications system 200. For example, the CORESET resource configurations 400 illustrate various configurations that enable the use of a WUS to dynamically indicate utilization of one or more parts of a set of CORESET resources in transmissions. Each of the CORESET resource configurations 400 may illustrate PDSCH resources 305, a CORESET 310, an indication 405, a wakeup occasion 320, and a WUS 325 in time, as described further with reference to FIGS. 1, 2, and 3.

A network entity may provide an indication (e.g., to a UE) of which parts 315 of the CORESET 310 may be active (e.g., may be utilized for control information) and, in some examples, may also verify the active parts 315 via an indication 405. For example, the network entity may communicate configuration information indicating the one or more parts 315 of a CORESET 310 to a UE, along with an indication to monitor for a WUS 325. In some examples, each CORESET 310 may include two parts 315 while, in other examples, each CORESET 310 may include a quantity of parts 315. During a wakeup occasion 320, the network entity may transmit a WUS 325 to the UE. The WUS 325 may indicate to the UE whether one or more of the parts 315 of the CORESET 310 may be active and may thus be utilized for the communication of control information. In response to receiving the WUS 325, the UE may monitor for a transmission of control information, data information, or a combination thereof via the PDSCH resources 305 from the network entity. In some examples, the network entity may transmit an indication 405 in downlink control information (DCI), CRC bits, or a combination thereof for verifying the active parts 315, the inactive parts 315, or both, of the CORESET 310. The UE may compare the CORESET parts indicated by the WUS 325 (e.g., the active parts 315, the inactive parts 315) to the parts 315 indicated by the indication 405 (e.g., indicated by the DCI, indicated by the CRC bits) to confirm that the parts 315 indicated by the WUS 325 and the parts 315 indicated by the indication 405 match. In some examples, the WUS 325 may be PDCCH-based, sequence-based, or a low-power WUS.

In some cases, the indication 405 may be an example of one or more DCI bits indicating the active parts 315 (or inactive parts) of the CORESET 310. For example, the network entity may use one or more DCI bits to re-transmit bits from the WUS 325 indicating the active parts 315, the inactive parts 315, or both, of the CORESET 310 to the UE. The one or more DCI bits may act as an indication 405 of the PDSCH resource 305 rate matching pattern around the CORESET 310. In the case that the indication 405 (e.g., the one or more DCI bits) may indicate active parts 315 that are different from the parts 315 indicated by the WUS 325, the UE may disregard the parts 315 indicated by the WUS 325 and may instead monitor or skip monitoring according to the indication 405 by the DCI bits.

In some cases, the DCI may include one or more CRC bits that the UE may also use to verify the active parts 315, the inactive parts, or both, of the CORESET 310. For example, the network entity may transmit one or more CRC bits to the UE such that the UE may use the CRC bits to verify the active parts 315 of the CORESET 310 indicated by the WUS 325. The one or more CRC bits may act as an indication 405 of the PDSCH resource 305 rate matching pattern around the CORESET 310. In some examples, the network entity may perform additional scrambling operations to combine a sequence of data with associated CRC bits to indicate which parts 315 of the CORESET 310 may be active or inactive. The UE may receive the scrambled bits, and may compare the scrambled bits to the bits received in the WUS 325 to verify the indicated parts 315 of the WUS 325. In some other examples, the UE may utilize reserved CRC bits of the DCI to confirm the bits of the WUS 325 indicating the active parts 315 of the CORESET 310. For example, a radio network temporary identifier (RNTI) may scramble data and CRC bits according to the below equation:

$$x bits + ( 24 - x CRC bits )$$

In this case, the network entity may use the first x bits as the indication 405 of the active, or inactive, parts of the CORESET 310. In some cases, the network entity may utilize scrambling or reserved CRC bits to explicitly indicate the active parts 315, the inactive parts, or both, of the CORESET 310 to the UE. For example, the network entity may use a CRC mask that may indicate which one or more parts 315 of the CORESET 310 is active such that the UE may verify the parts 315 that may be used to rate match the PDSCH resource 305 around the CORESET 310. For example, a first CRC mask may indicate that all of the CORESET parts are inactive, a second CRC mask may indicate that a first part of the CORESET is active, and a third CRC mask may indicate that a second part of the CORESET is active, and a third CRC mask may indicate that all or multiple parts of the CORESET are active. In the case that the one or more CRC bits of the CRC make may indicate active parts 315 that are different from the parts 315 indicated by the WUS 325 to be active, the UE may disregard the parts 315 indicated by the CRC bits and may instead monitor or skip monitoring according to the CRC bits (e.g., the UE may default to the active parts 315 indicated by the DCI bits of the indication 405).

In some cases, a single bit in the DCI bit may indicate the active parts 315, the inactive parts, or both, of the CORESET 310. For example, after DCI decoding successful, the UE may use a single DCI bit to verify the active parts 315 of the CORESET 310, for determining a rate matching pattern around the CORESET 310. For example, in the case that a control message may be received within an active part 315 of the CORESET 310, a DCI bit of “1” (e.g., included in the indication 405) may indicate to the UE that the inactive parts 315 may be used for PDSCH rate matching (e.g., the inactive parts 315 do not include a PDCCH transmission for other UEs) and thus should be monitored for data transmission. In other examples, a DCI bit of “0” (e.g., included in the indication 405) may indicate to the UE that resources of the CORESET outside of an active part 315 may not be used for PDSCH rate matching and thus should not be monitored (e.g., the active parts 315 may be utilized for PDCCH transmission to other UE 115). In some examples, the UE may not rate match the PDSCH resources 350 around all other CORESET 310 parts in the case that the network may not confirm that only the active CORESET 310 part may be used for PDCCH transmissions at that instance.

In the example of CORESET resource configuration 400-a, a part 315-h of the CORESET 310-e that is outside the active part 315-g may be utilized for rate matching PDSCH resources 305-c. For example, during the wakeup occasion 320-e, the network entity may transmit and the UE may receive a WUS 325-e indicating that the part 315-g of the CORESET 310-e may be active. The network entity may also transmit an indication 405-a as part of a control message received via the active part 315-g. In some examples, the indication 405-a may indicate to the UE that the part 315-h may be utilized for rate matching PDSCH resources 305 (e.g., as described further herein). In response to the WUS 325-e indicating the part 315-g to be active and in response to the indication 405 indicating that the part 315-h may be utilized for rate matching, the UE may monitor PDCCH resources associated with the part 315-g and may skip monitoring PDCCH resources associated with the part 315-h for control resources (e.g., as there is no PDCCH transmission in the part 315-h). The UE may instead monitor both the PDSCH resources 305-c and the part 315-h of the CORESET 310-e for data transmissions.

In the example of CORESET resource configuration 400-b, a part 315-j of the CORESET 310-f that is outside the active part 315-i may not be utilized for rate matching PDSCH resources 305-f. For example, during the wakeup occasion 320-f, the network entity may transmit and the UE may receive a WUS 325-f indicating that the part 315-i of the CORESET 310-f may be active. The network entity may also transmit an indication 405-b as part of a control message received via the active part 315-i. In some examples, the indication 405-b may indicate to the UE that the part 315-j may not be utilized for rate matching PDSCH resources 305 (e.g., as described further herein). In response to the WUS 325-f indicating the part 315-i to be active and in response to the indication 405 indicating that the part 315-j may not be utilized for rate matching, the UE may monitor PDCCH resources associated with the part 315-i and the part 315-j. In some examples, the UE may not monitor the part 315-j, as the part 315-j may be utilized by another UE. The UE may monitor the PDSCH resources 305-f for data transmissions.

In some examples, the UE may receive DCI via the PDCCH that may be an uplink grant. In the case that the DCI information includes an uplink grant, the UE may not perform PDSCH rate matching resource 305 around the CORESET 310. In some examples, the network entity may transmit the WUS 325 that includes one of two different RNTIs to indicate whether the PDCCH carries a PDSCH grant for the UE. For example, the network entity may transmit a WUS 325 that includes a first RNTI to indicate that a PDCCH of a CORESET part of the CORESET includes the PDSCH grant. In another example, the network entity may transmit a WUS 325 that includes a second RNTI, that differs from the first RNTI, to indicate that a PDCCH of a CORESET part of the CORESET includes other control information (e.g., an uplink grant) besides a PDSCH grant. In some other examples, whether the WUS 325 includes a RNTI may be used to indicate whether a PDCCH of a CORESET part of the CORESET includes the PDSCH grant (e.g., DCI). For example, the network entity may transmit the WUS 325 that includes a RNTI to indicate that the PDCCH may carry a PDSCH grant for the UE. In another example, the network entity may transmit the WUS 325 that does not include the RNTI to indicate that the PDCCH of a CORESET part of the CORESET includes other control information (e.g., an uplink grant) besides a PDSCH grant.

Techniques of the present disclosure may increase reliability and efficiency by enabling a UE to determine which parts 315 of the CORESET 310 may be active (e.g., associated with the transmission of control data). Techniques described herein may improve communications between the network entity and the UE by enabling the network entity to communicate with the UE whether the UE may monitor or skip monitoring an associated PDCCH for various data, and by reusing the WUS 325 resources. Additionally, a WUS-based CORESET resource adaptation may be detected in various lower power modes (e.g., SDR, LP-WUR). For example, a WUS-based CORESET resource adaptation may be more easily detected in lower power receptions than CFI-based CORESET resource adaptation. As such, techniques described herein may enable more efficient utilization of communication resources, improved communication reliability, reduced overhead associated with dynamic rate matching, decreased power consumption, reduced complexity, data rate throughput enhancement, and improved operation efficiency of the UE.

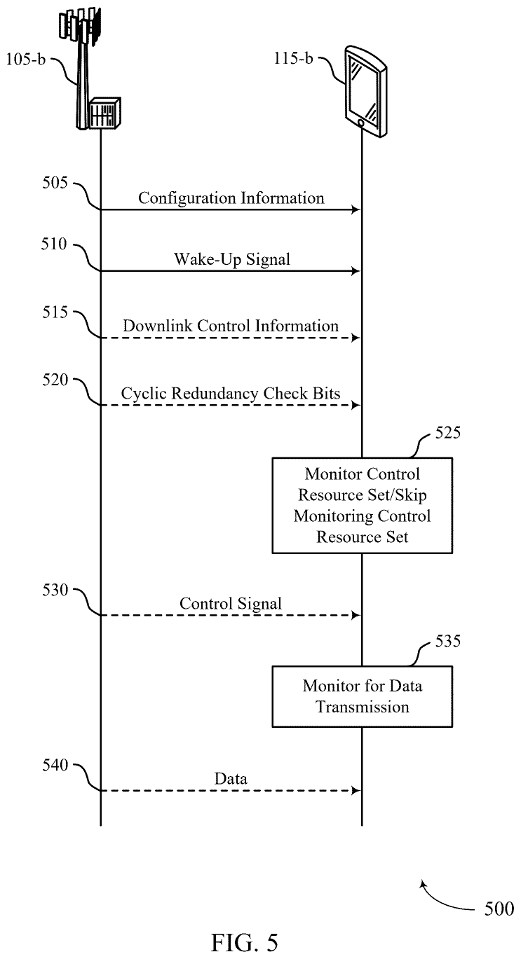

FIG. 5 shows an example of a process flow 500 that supports WUS based CORESET adaptation and PDSCH rate matching in accordance with one or more aspects of the present disclosure. Aspects of the process flow 500 may implement, or be implemented by, aspects of the wireless communications system 100 or the wireless communications system 200. For example, the process flow 500 illustrates various signals and operations that enable the use of a WUS to dynamically indicate utilization of one or more parts of a set of CORESET resources in transmissions.

The process flow 500 includes a UE 115-b and a network entity 105-b, which may be examples of UEs 115, network entities 105, and other wireless devices as described herein. For example, the UE 115-b and the network entity 105-b illustrated in FIG. 5 may include examples of the UE 115-a and the network entity 105-a, respectively, as illustrated in FIG. 2.

In some examples, the operations illustrated in process flow 500 may be performed by hardware (e.g., including circuitry, processing blocks, logic components, and other components), code such as processor-executable code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the network entity 105-b may transmit, and the UE 115-b may receive, configuration information. The configuration information may indicate one or more parts of a control resource set (e.g., a CORESET), may indicate for the UE 115-b to monitor a wakeup occasion for a WUS, or both.

At 510, the network entity 105-b may transmit, and the UE 115-b may receive, a WUS via the wakeup occasion. For example, based on receiving the indication to monitor the wakeup occasion, the UE 115-b may receive a WUS during a wakeup occasion. The WUS may indicate whether one or more control resource set parts of the one or more parts of the control resource set is active (e.g., being utilized for control data transmissions). In some examples, the WUS may include one or more bits that may indicate whether one or more control resource set parts is active. In some examples, the WUS may be an example of a RNTI indicating whether the one or more control resource set parts includes a grant for a downlink transmission or control information (e.g., that may be different than a downlink transmission grant). For example, a presence or an absence of a RNTI in the WUS may indicate to the UE 115-b whether the one or more control resource set parts includes a grant for a downlink transmission or control information. In some other examples, the WUS may be an example of a PDCCH based WUS, a sequence-based WUS, or a low power WUS.

At 515, in some examples, the network entity 105-b may transmit, and the UE 115-b may receive, DCI via at least one CORESET part of the CORESET. For example, based on receiving the WUS, the UE 115-b may receive DCI indicating whether the one or more control resource set parts of the plurality of parts of the control resource set is active. The network entity 105-b may transmit (e.g., and the UE 115-b receive) the DCI via a first control resource set part of the one or more control resource set parts. In some other examples, the network entity 105-b may transmit (e.g., and the UE 115-b receive) DCI including a bit that may indicate activation of the one or more control resource set parts of the control resource set.

At 520, in some examples, the network entity 105-b may transmit, and the UE 115-b may receive, CRC bits, where the CRC bits may be included in the DCI. For example, based on receiving the WUS, the UE 115-b may receive one or more CRC bits indicating whether the one or more control resource set parts of the plurality of parts of the control resource set is active. The network entity 105-b may transmit (e.g., and the UE 115-b receive) DCI including the one or more CRC bits via a first control resource set part of the one or more control resource set parts.

At 525, the UE 115-b may monitor, or skip the monitoring of, a control resource set. For example, based on receiving the configuration information and the WUS, the UE 115-b may monitor or skip the monitoring of one or more control resource set parts of the control resource set. In the case that the WUS may indicate to the UE 115-b that the one or more control resource set parts may be inactive, the UE 115-b may refrain from (e.g., skip) monitoring the one or more control resource set parts. For example, the UE 115-b may skip monitoring the one or more control resource set parts in the case that the WUS indicates that none of the one or more control resource set parts may be active. In the case that the WUS may indicate to the UE 115-b that the one or more control resource set parts may be active, the UE 115-b may monitor the one or more control resource set parts. For example, the UE 115-b may monitor the one or more control resource set parts in the case that the WUS indicates that at least one of the one or more control resource set parts may be active.

At 530, in some examples, the network entity 105-b may transmit, and the UE 115-b may receive, control signaling. In the case that the WUS may indicate to the UE 115-b that the one or more control resource set parts may be active, and based on monitoring the control resource set, the UE may receive control signaling via one or more active control resource set parts of the control resource set.

At 535, the UE 115-b may monitor for one or more data transmissions. Based on the WUS indicating the one or more control resource set parts to be inactive, the UE 115-b may monitor for one or more data transmissions from the network entity 105-b within the one or more inactive control resource set parts of the one or more parts of the control resource set. For example, instead of monitoring for control information within the control resource set, the UE 115-b may monitor for a data transmission within the one or more parts of the control resource set in response to the WUS indicating the one or more control resource set parts to be inactive.

At 540, in some examples, the network entity 105-b may transmit, and the UE 115-b may receive, one or more data transmissions. Based on the WUS indicating one or more control resource set parts to be inactive, and based on monitoring for one or more data transmissions, the UE may receive a data transmission from the network entity.

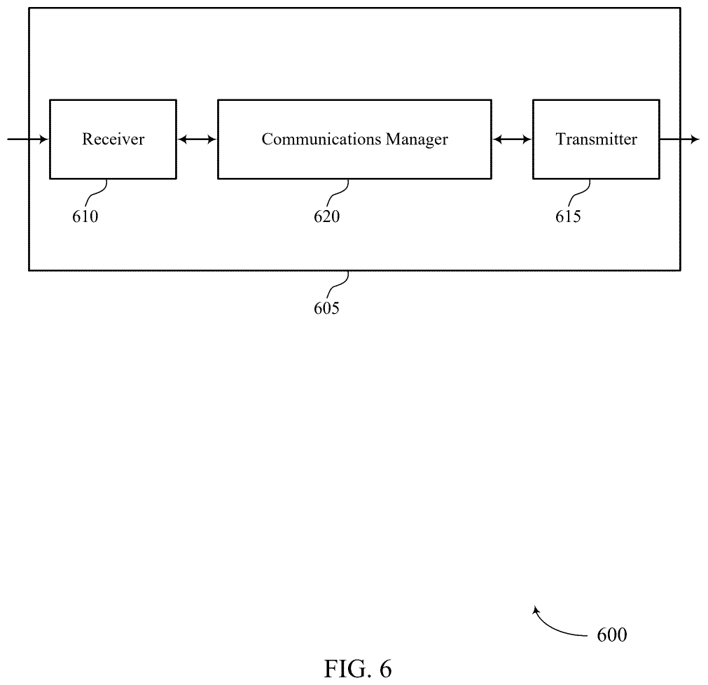

FIG. 6 shows a block diagram 600 of a device 605 that supports WUS based CORESET adaptation and PDSCH rate matching in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to WUS based CORESET adaptation and PDSCH rate matching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to WUS based CORESET adaptation and PDSCH rate matching). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of WUS based CORESET adaptation and PDSCH rate matching as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, from a network entity, configuration information indicating a set of multiple parts of a control resource set and indicating to monitor a wakeup occasion for a wake-up signal, the wakeup occasion occurring prior to the control resource set. The communications manager 620 is capable of, configured to, or operable to support a means for receiving, during the wakeup occasion and based on the configuration information, the wake-up signal indicating whether one or more control resource set parts of the set of multiple parts of the control resource set is active. The communications manager 620 is capable of, configured to, or operable to support a means for monitoring, or skipping monitoring of, the one or more control resource set parts of the control resource set based on the configuration information and the wake-up signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources.

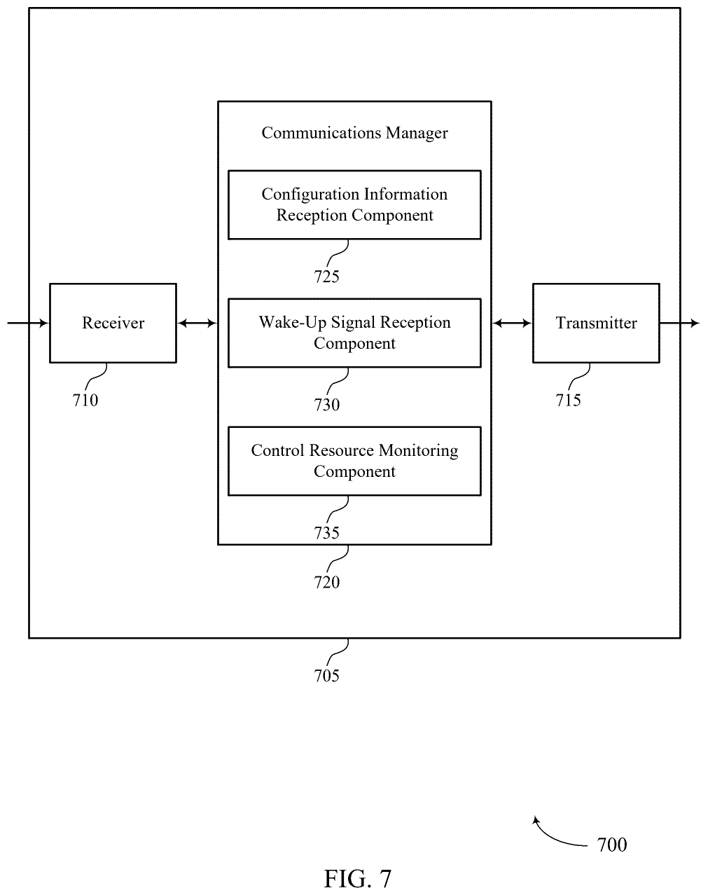

FIG. 7 shows a block diagram 700 of a device 705 that supports WUS based CORESET adaptation and PDSCH rate matching in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to WUS based CORESET adaptation and PDSCH rate matching). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to WUS based CORESET adaptation and PDSCH rate matching). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of WUS based CORESET adaptation and PDSCH rate matching as described herein. For example, the communications manager 720 may include a configuration information reception component 725, a wake-up signal reception component 730, a control resource monitoring component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration information reception component 725 is capable of, configured to, or operable to support a means for receiving, from a network entity, configuration information indicating a set of multiple parts of a control resource set and indicating to monitor a wakeup occasion for a wake-up signal, the wakeup occasion occurring prior to the control resource set. The wake-up signal reception component 730 is capable of, configured to, or operable to support a means for receiving, during the wakeup occasion and based on the configuration information, the wake-up signal indicating whether one or more control resource set parts of the set of multiple parts of the control resource set is active. The control resource monitoring component 735 is capable of, configured to, or operable to support a means for monitoring, or skipping monitoring of, the one or more control resource set parts of the control resource set based on the configuration information and the wake-up signal.

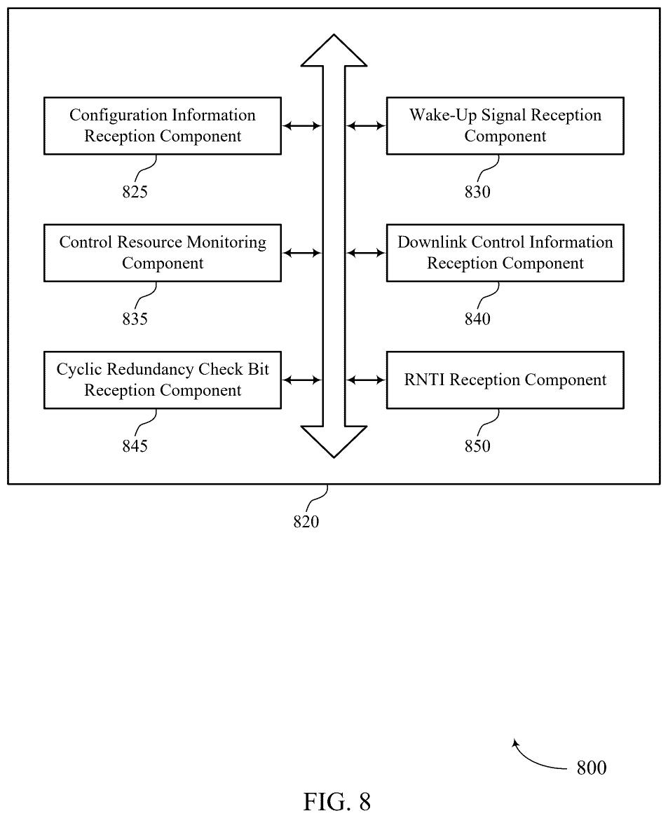

FIG. 8 shows a block diagram 800 of a communications manager 820 that supports WUS based CORESET adaptation and PDSCH rate matching in accordance with one or more aspects of the present disclosure. The communications manager 820 may be an example of aspects of a communications manager 620, a communications manager 720, or both, as described herein. The communications manager 820, or various components thereof, may be an example of means for performing various aspects of WUS based CORESET adaptation and PDSCH rate matching as described herein. For example, the communications manager 820 may include a configuration information reception component 825, a wake-up signal reception component 830, a control resource monitoring component 835, a downlink control information reception component 840, a cyclic redundancy check bit reception component 845, an RNTI reception component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration information reception component 825 is capable of, configured to, or operable to support a means for receiving, from a network entity, configuration information indicating a set of multiple parts of a control resource set and indicating to monitor a wakeup occasion for a wake-up signal, the wakeup occasion occurring prior to the control resource set. The wake-up signal reception component 830 is capable of, configured to, or operable to support a means for receiving, during the wakeup occasion and based on the configuration information, the wake-up signal indicating whether one or more control resource set parts of the set of multiple parts of the control resource set is active. The control resource monitoring component 835 is capable of, configured to, or operable to support a means for monitoring, or skipping monitoring of, the one or more control resource set parts of the control resource set based on the configuration information and the wake-up signal.

In some examples, the control resource monitoring component 835 is capable of, configured to, or operable to support a means for monitoring for data transmission within the one or more control resource set parts of the set of multiple parts of the control resource set based on the wake-up signal indicating the one or more control resource set parts of the set of multiple parts of the control resource set to be inactive.

In some examples, to support receiving the wake-up signal, the wake-up signal reception component 830 is capable of, configured to, or operable to support a means for receiving the wake-up signal including one or more bits indicating whether the one or more control resource set parts of the set of multiple parts of the control resource set is active.

In some examples, the downlink control information reception component 840 is capable of, configured to, or operable to support a means for receiving, via a first control resource set part of the set of multiple parts of the control resource set and based on the wake-up signal, downlink control information indicating whether the one or more control resource set parts of the set of multiple parts of the control resource set is active.

In some examples, the cyclic redundancy check bit reception component 845 is capable of, configured to, or operable to support a means for receiving, via a first control resource set part of the set of multiple parts of the control resource set and based on the wake-up signal, one or more cyclic redundancy check bits indicating whether the one or more control resource set parts of the set of multiple parts of the control resource set is active.

In some examples, the downlink control information reception component 840 is capable of, configured to, or operable to support a means for receiving, via a first control resource set part of the set of multiple parts of the control resource set and based on the wake-up signal, a downlink control information including a bit indicating activation of the one or more control resource set parts of the control resource set.

In some examples, the RNTI reception component 850 is capable of, configured to, or operable to support a means for receiving the wake-up signal including a RNTI, the RNTI indicating whether the one or more control resource set parts of the control resource set includes a grant for a downlink transmission or control information other than a downlink transmission grant.

In some examples, presence or absence of a RNTI in the wake-up signal indicates whether the one or more control resource set parts of the control resource set includes a grant for a downlink transmission or control information other than a downlink transmission grant.

In some examples, the wake-up signal is a PDCCH transmission, a sequence-based wake-up signal, or a low power wake-up signal.

In some examples, the monitoring is skipped based on the wake-up signal indicating that none of the set of multiple parts of the control resource set is active.

In some examples, the monitoring is performed based on the wake-up signal indicating that at least one of the set of multiple parts of the control resource set is active.

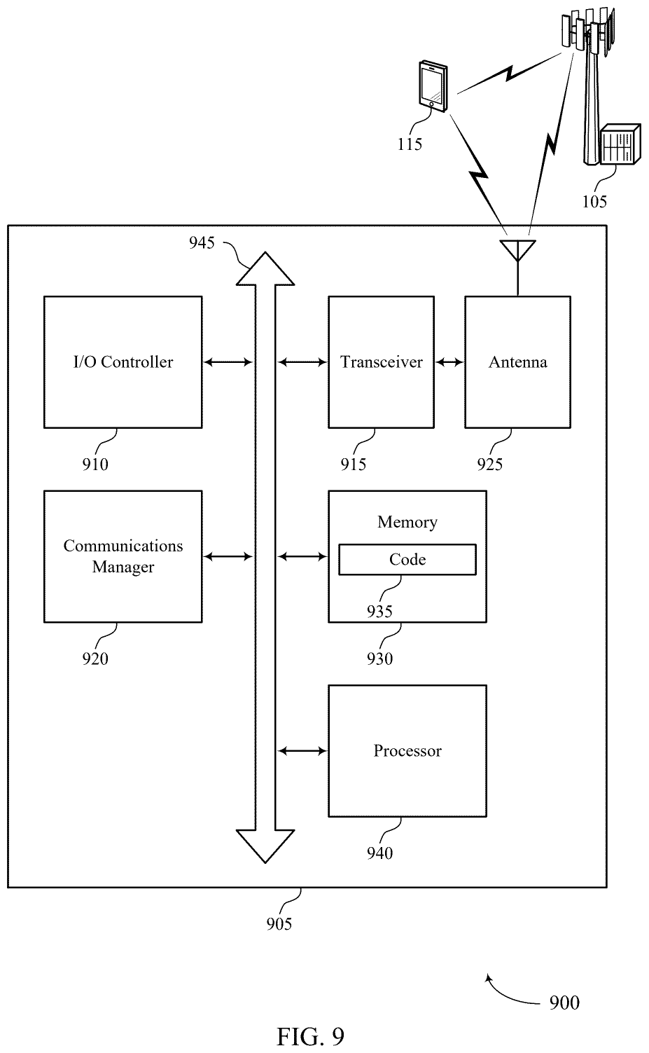

FIG. 9 shows a diagram of a system 900 including a device 905 that supports WUS based CORESET adaptation and PDSCH rate matching in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting WUS based CORESET adaptation and PDSCH rate matching). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving, from a network entity, configuration information indicating a set of multiple parts of a control resource set and indicating to monitor a wakeup occasion for a wake-up signal, the wakeup occasion occurring prior to the control resource set. The communications manager 920 is capable of, configured to, or operable to support a means for receiving, during the wakeup occasion and based on the configuration information, the wake-up signal indicating whether one or more control resource set parts of the set of multiple parts of the control resource set is active. The communications manager 920 is capable of, configured to, or operable to support a means for monitoring, or skipping monitoring of, the one or more control resource set parts of the control resource set based on the configuration information and the wake-up signal.

By including or configuring the communications manager 920 in accordance with examples as described herein, the device 905 may support techniques for improved communication reliability, reduced latency, improved user experience related to reduced processing, reduced power consumption, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of WUS based CORESET adaptation and PDSCH rate matching as described herein, or the at least one processor 940 and the at least one memory 930 may be otherwise configured to, individually or collectively, perform or support such operations.

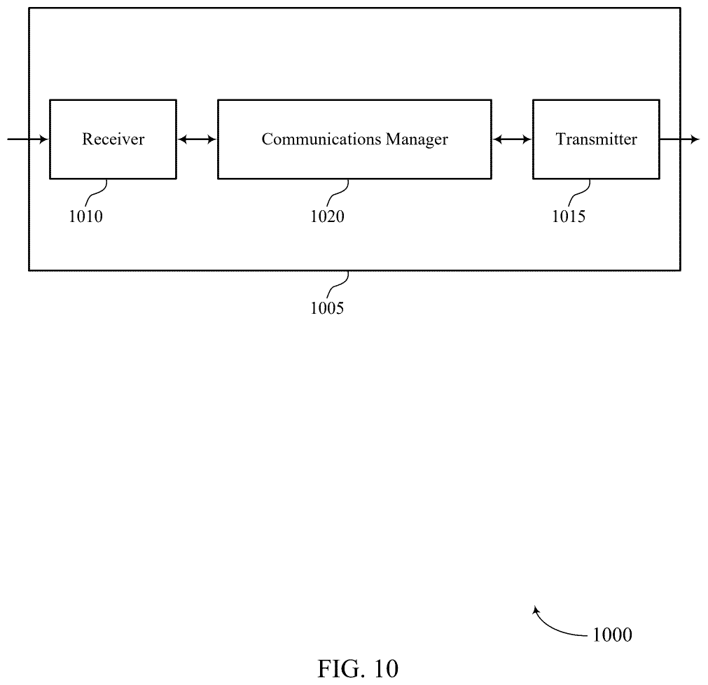

FIG. 10 shows a block diagram 1000 of a device 1005 that supports WUS based CORESET adaptation and PDSCH rate matching in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of WUS based CORESET adaptation and PDSCH rate matching as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting, to a UE, configuration information indicating a set of multiple parts of a control resource set and indicating to monitor a wakeup occasion for a wake-up signal, the wakeup occasion occurring prior to the control resource set. The communications manager 1020 is capable of, configured to, or operable to support a means for transmitting, during the wakeup occasion and based on the configuration information, the wake-up signal indicating that one or more control resource set parts of the set of multiple parts of the control resource set is active. The communications manager 1020 is capable of, configured to, or operable to support a means for transmitting, to the UE, at least one control message via the one or more control resource set parts of the control resource set based on the configuration information and the wake-up signal.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

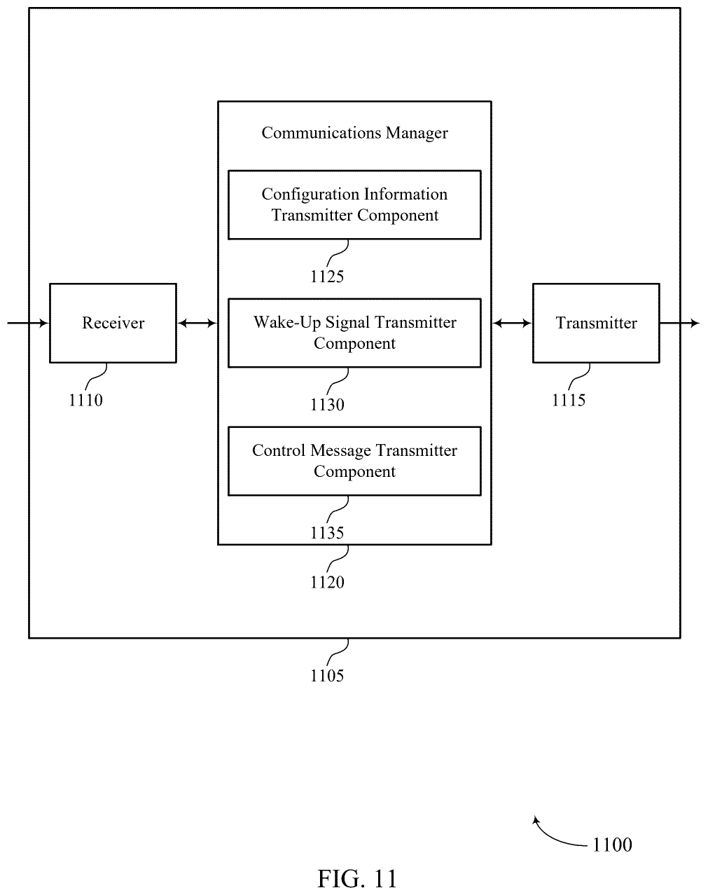

FIG. 11 shows a block diagram 1100 of a device 1105 that supports WUS based CORESET adaptation and PDSCH rate matching in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of WUS based CORESET adaptation and PDSCH rate matching as described herein. For example, the communications manager 1120 may include a configuration information transmitter component 1125, a wake-up signal transmitter component 1130, a control message transmitter component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The configuration information transmitter component 1125 is capable of, configured to, or operable to support a means for transmitting, to a UE, configuration information indicating a set of multiple parts of a control resource set and indicating to monitor a wakeup occasion for a wake-up signal, the wakeup occasion occurring prior to the control resource set. The wake-up signal transmitter component 1130 is capable of, configured to, or operable to support a means for transmitting, during the wakeup occasion and based on the configuration information, the wake-up signal indicating that one or more control resource set parts of the set of multiple parts of the control resource set is active. The control message transmitter component 1135 is capable of, configured to, or operable to support a means for transmitting, to the UE, at least one control message via the one or more control resource set parts of the control resource set based on the configuration information and the wake-up signal.

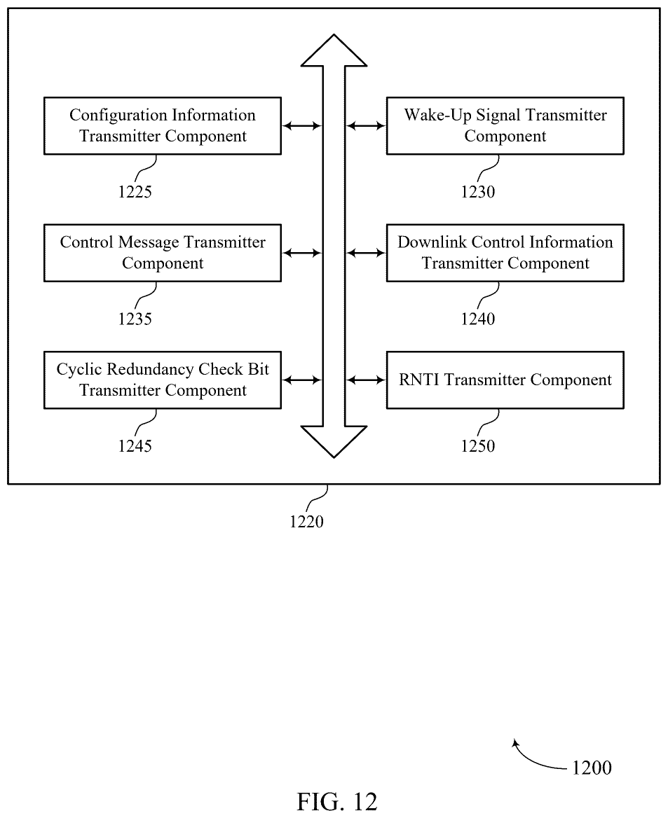

FIG. 12 shows a block diagram 1200 of a communications manager 1220 that supports WUS based CORESET adaptation and PDSCH rate matching in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of WUS based CORESET adaptation and PDSCH rate matching as described herein. For example, the communications manager 1220 may include a configuration information transmitter component 1225, a wake-up signal transmitter component 1230, a control message transmitter component 1235, a downlink control information transmitter component 1240, a cyclic redundancy check bit transmitter component 1245, an RNTI transmitter component 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The configuration information transmitter component 1225 is capable of, configured to, or operable to support a means for transmitting, to a UE, configuration information indicating a set of multiple parts of a control resource set and indicating to monitor a wakeup occasion for a wake-up signal, the wakeup occasion occurring prior to the control resource set. The wake-up signal transmitter component 1230 is capable of, configured to, or operable to support a means for transmitting, during the wakeup occasion and based on the configuration information, the wake-up signal indicating that one or more control resource set parts of the set of multiple parts of the control resource set is active. The control message transmitter component 1235 is capable of, configured to, or operable to support a means for transmitting, to the UE, at least one control message via the one or more control resource set parts of the control resource set based on the configuration information and the wake-up signal.

In some examples, to support transmitting the wake-up signal, the wake-up signal transmitter component 1230 is capable of, configured to, or operable to support a means for transmitting the wake-up signal including one or more bits indicating which of the set of multiple parts of the control resource set is active.

In some examples, the downlink control information transmitter component 1240 is capable of, configured to, or operable to support a means for transmitting, via a first control resource set part of the set of multiple parts of the control resource set and based on the wake-up signal, downlink control information indicating which of the set of multiple parts of the control resource set is active.

In some examples, the cyclic redundancy check bit transmitter component 1245 is capable of, configured to, or operable to support a means for transmitting, via a first control resource set part of the set of multiple parts of the control resource set and based on the wake-up signal, one or more cyclic redundancy check bits indicating which of the set of multiple parts of the control resource set is active.

In some examples, the downlink control information transmitter component 1240 is capable of, configured to, or operable to support a means for transmitting, via a first control resource set part of the set of multiple parts of the control resource set and based on the wake-up signal, a downlink control information including a bit indicating activation of the one or more control resource set parts of the control resource set.

In some examples, the RNTI transmitter component 1250 is capable of, configured to, or operable to support a means for receiving the wake-up signal including a RNTI, the RNTI indicating whether the one or more control resource set parts of the control resource set includes a grant for a downlink transmission or control information other than a downlink transmission grant.

In some examples, presence or absence of a RNTI in the wake-up signal indicates whether the one or more control resource set parts of the control resource set includes a grant for a downlink transmission or control information other than a downlink transmission grant.

In some examples, the wake-up signal is a PDCCH transmission, a sequence-based wake-up signal, or a low power wake-up signal.

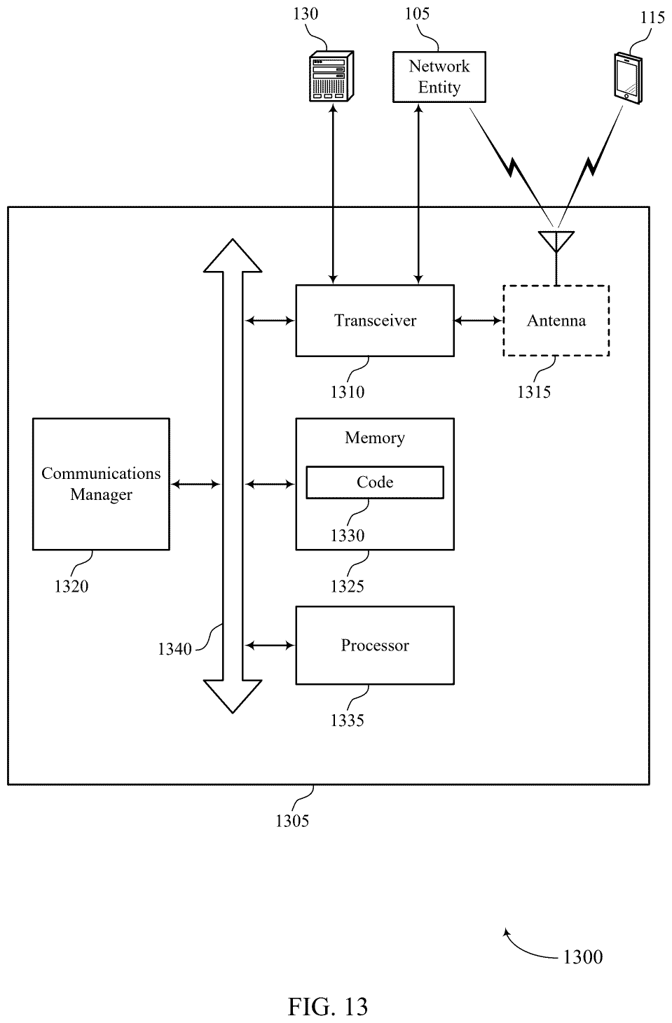

FIG. 13 shows a diagram of a system 1300 including a device 1305 that supports WUS based CORESET adaptation and PDSCH rate matching in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting WUS based CORESET adaptation and PDSCH rate matching). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting, to a UE, configuration information indicating a set of multiple parts of a control resource set and indicating to monitor a wakeup occasion for a wake-up signal, the wakeup occasion occurring prior to the control resource set. The communications manager 1320 is capable of, configured to, or operable to support a means for transmitting, during the wakeup occasion and based on the configuration information, the wake-up signal indicating that one or more control resource set parts of the set of multiple parts of the control resource set is active. The communications manager 1320 is capable of, configured to, or operable to support a means for transmitting, to the UE, at least one control message via the one or more control resource set parts of the control resource set based on the configuration information and the wake-up signal.

By including or configuring the communications manager 1320 in accordance with examples as described herein, the device 1305 may support techniques for improved communication reliability, reduced latency, improved user experience related to reduced processing, reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of WUS based CORESET adaptation and PDSCH rate matching as described herein, or the at least one processor 1335 and the at least one memory 1325 may be otherwise configured to, individually or collectively, perform or support such operations.

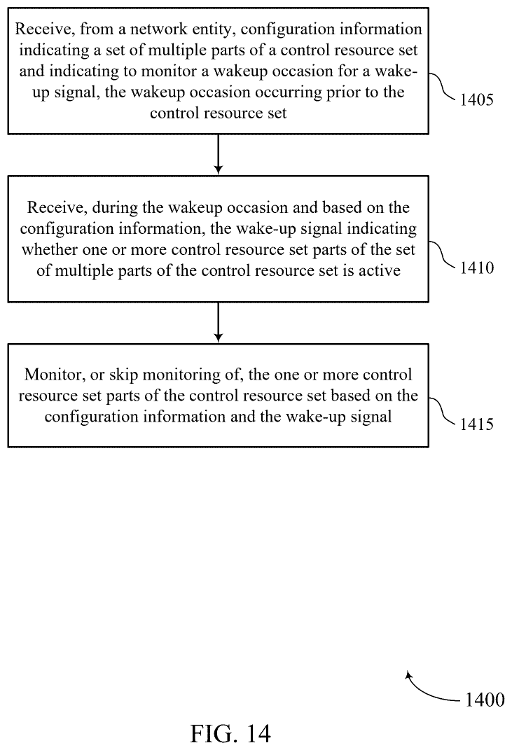

FIG. 14 shows a flowchart illustrating a method 1400 that supports WUS based CORESET adaptation and PDSCH rate matching in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, configuration information indicating a set of multiple parts of a control resource set and indicating to monitor a wakeup occasion for a wake-up signal, the wakeup occasion occurring prior to the control resource set. The operations of 1405 may be performed in accordance with examples as disclosed herein. In some examples, aspects of the operations of 1405 may be performed by a configuration information reception component 825 as described with reference to FIG. 8.

At 1410, the method may include receiving, during the wakeup occasion and based on the configuration information, the wake-up signal indicating whether one or more control resource set parts of the set of multiple parts of the control resource set is active. The operations of 1410 may be performed in accordance with examples as disclosed herein. In some examples, aspects of the operations of 1410 may be performed by a wake-up signal reception component 830 as described with reference to FIG. 8.

At 1415, the method may include monitoring, or skipping monitoring of, the one or more control resource set parts of the control resource set based on the configuration information and the wake-up signal. The operations of 1415 may be performed in accordance with examples as disclosed herein. In some examples, aspects of the operations of 1415 may be performed by a control resource monitoring component 835 as described with reference to FIG. 8.

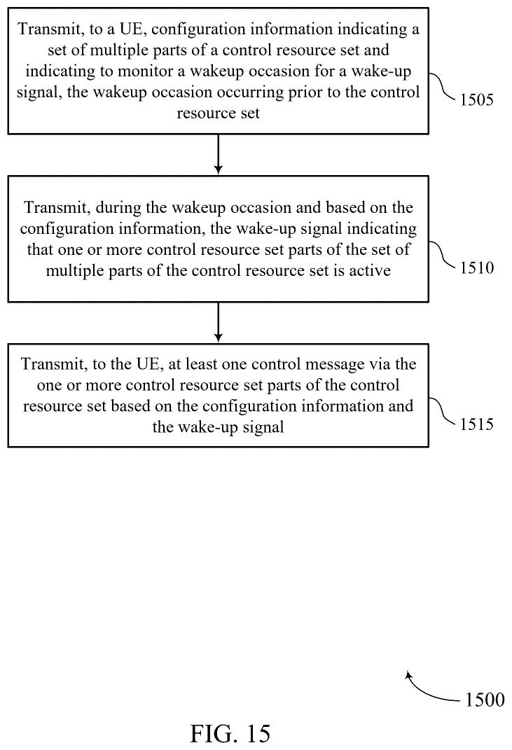

FIG. 15 shows a flowchart illustrating a method 1500 that supports WUS based CORESET adaptation and PDSCH rate matching in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, configuration information indicating a set of multiple parts of a control resource set and indicating to monitor a wakeup occasion for a wake-up signal, the wakeup occasion occurring prior to the control resource set. The operations of 1505 may be performed in accordance with examples as disclosed herein. In some examples, aspects of the operations of 1505 may be performed by a configuration information transmitter component 1225 as described with reference to FIG. 12.

At 1510, the method may include transmitting, during the wakeup occasion and based on the configuration information, the wake-up signal indicating that one or more control resource set parts of the set of multiple parts of the control resource set is active. The operations of 1510 may be performed in accordance with examples as disclosed herein. In some examples, aspects of the operations of 1510 may be performed by a wake-up signal transmitter component 1230 as described with reference to FIG. 12.

At 1515, the method may include transmitting, to the UE, at least one control message via the one or more control resource set parts of the control resource set based on the configuration information and the wake-up signal. The operations of 1515 may be performed in accordance with examples as disclosed herein. In some examples, aspects of the operations of 1515 may be performed by a control message transmitter component 1235 as described with reference to FIG. 12.

The following provides an overview of aspects of the present disclosure:
Aspect 1: A method for wireless communications at a UE, comprising: receiving, from a network entity, configuration information indicating a plurality of parts of a control resource set and indicating to monitor a wakeup occasion for a wake-up signal, the wakeup occasion occurring prior to the control resource set; receiving, during the wakeup occasion and based at least in part on the configuration information, the wake-up signal indicating whether one or more control resource set parts of the plurality of parts of the control resource set is active; and monitoring, or skip monitoring of, the one or more control resource set parts of the control resource set based at least in part on the configuration information and the wake-up signal.
Aspect 2: The method of aspect 1, comprising: monitoring for data transmission within the one or more control resource set parts of the plurality of parts of the control resource set based at least in part on the wake-up signal indicating the one or more control resource set parts of the plurality of parts of the control resource set to be inactive.
Aspect 3: The method of any of aspects 1 through 2, wherein receiving the wake-up signal comprises: receiving the wake-up signal comprising one or more bits indicating whether the one or more control resource set parts of the plurality of parts of the control resource set is active.
Aspect 4: The method of any of aspects 1 through 3, comprising: receiving, via a first control resource set part of the plurality of parts of the control resource set and based at least in part on the wake-up signal, downlink control information indicating whether the one or more control resource set parts of the plurality of parts of the control resource set is active.
Aspect 5: The method of any of aspects 1 through 4, comprising: receiving, via a first control resource set part of the plurality of parts of the control resource set and based at least in part on the wake-up signal, one or more cyclic redundancy check bits indicating whether the one or more control resource set parts of the plurality of parts of the control resource set is active.
Aspect 6: The method of any of aspects 1 through 5, comprising: receiving, via a first control resource set part of the plurality of parts of the control resource set and based at least in part on the wake-up signal, a downlink control information comprising a bit indicating activation of the one or more control resource set parts of the control resource set.
Aspect 7: The method of any of aspects 1 through 6, comprising: receiving the wake-up signal comprising an RNTI, the RNTI indicating whether the one or more control resource set parts of the control resource set comprises a grant for a downlink transmission or control information other than a downlink transmission grant.
Aspect 8: The method of any of aspects 1 through 7, wherein presence or absence of an RNTI in the wake-up signal indicates whether the one or more control resource set parts of the control resource set comprises a grant for a downlink transmission or control information other than a downlink transmission grant.
Aspect 9: The method of any of aspects 1 through 8, wherein the wake-up signal is a PDCCH transmission, a sequence-based wake-up signal, or a low power wake-up signal.
Aspect 10: The method of any of aspects 1 through 9, wherein the monitoring is skipped based at least in part on the wake-up signal indicating that none of the plurality of parts of the control resource set is active.
Aspect 11: The method of any of aspects 1 through 10, wherein the monitoring is performed based at least in part on the wake-up signal indicating that at least one of the plurality of parts of the control resource set is active.
Aspect 12: A method for wireless communications at a network entity, comprising: transmitting, to a UE, configuration information indicating a plurality of parts of a control resource set and indicating to monitor a wakeup occasion for a wake-up signal, the wakeup occasion occurring prior to the control resource set; transmitting, during the wakeup occasion and based at least in part on the configuration information, the wake-up signal indicating that one or more control resource set parts of the plurality of parts of the control resource set is active; and transmitting, to the UE, at least one control message via the one or more control resource set parts of the control resource set based at least in part on the configuration information and the wake-up signal.
Aspect 13: The method of aspect 12, wherein transmitting the wake-up signal comprises: transmitting the wake-up signal comprising one or more bits indicating which of the plurality of parts of the control resource set is active.
Aspect 14: The method of any of aspects 12 through 13, comprising: transmitting, via a first control resource set part of the plurality of parts of the control resource set and based at least in part on the wake-up signal, downlink control information indicating which of the plurality of parts of the control resource set is active.
Aspect 15: The method of any of aspects 12 through 14, comprising: transmitting, via a first control resource set part of the plurality of parts of the control resource set and based at least in part on the wake-up signal, one or more cyclic redundancy check bits indicating which of the plurality of parts of the control resource set is active.
Aspect 16: The method of any of aspects 12 through 15, comprising: transmitting, via a first control resource set part of the plurality of parts of the control resource set and based at least in part on the wake-up signal, a downlink control information comprising a bit indicating activation of the one or more control resource set parts of the control resource set.
Aspect 17: The method of any of aspects 12 through 16, comprising: receiving the wake-up signal comprising an RNTI, the RNTI indicating whether the one or more control resource set parts of the control resource set comprises a grant for a downlink transmission or control information other than a downlink transmission grant.
Aspect 18: The method of any of aspects 12 through 17, wherein presence or absence of a RNTI in the wake-up signal indicates whether the one or more control resource set parts of the control resource set comprises a grant for a downlink transmission or control information other than a downlink transmission grant.
Aspect 19: The method of any of aspects 12 through 18, wherein the wake-up signal is a PDCCH transmission, a sequence-based wake-up signal, or a low power wake-up signal.
Aspect 20: A UE for wireless communications, comprising one or more memories storing processor-executable code, and one or more processors coupled with the one or more memories and individually or collectively operable to execute the code to cause the UE to perform a method of any of aspects 1 through 11.
Aspect 21: A UE for wireless communications, comprising at least one means for performing a method of any of aspects 1 through 11.
Aspect 22: A non-transitory computer-readable medium storing code for wireless communications, the code comprising instructions executable by one or more processors to perform a method of any of aspects 1 through 11.
Aspect 23: A network entity for wireless communications, comprising one or more memories storing processor-executable code, and one or more processors coupled with the one or more memories and individually or collectively operable to execute the code to cause the network entity to perform a method of any of aspects 12 through 19.
Aspect 24: A network entity for wireless communications, comprising at least one means for performing a method of any of aspects 12 through 19.
Aspect 25: A non-transitory computer-readable medium storing code for wireless communications, the code comprising instructions executable by one or more processors to perform a method of any of aspects 12 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communications, comprising:
processing circuitry associated with one or more memory devices and configured to cause the UE to:
receive, from a network entity, configuration information indicating a plurality of parts of a control resource set and indicating to monitor a wakeup occasion for a wake-up signal, the wakeup occasion occurring prior to the control resource set;
receive, during the wakeup occasion and based at least in part on the configuration information, the wake-up signal indicating whether one or more control resource set parts of the plurality of parts of the control resource set is active; and
monitor, or skip monitoring of, the one or more control resource set parts of the control resource set based at least in part on the configuration information and the wake-up signal.

2. The UE of claim 1, wherein the processing circuitry is further configured to cause the UE to:
monitor for data transmission within the one or more control resource set parts of the plurality of parts of the control resource set based at least in part on the wake-up signal indicating the one or more control resource set parts of the plurality of parts of the control resource set to be inactive.

3. The UE of claim 1, wherein, to receive the wake-up signal, the processing circuitry is further configured to cause the UE to:
receive the wake-up signal comprising one or more bits indicating whether the one or more control resource set parts of the plurality of parts of the control resource set is active.

4. The UE of claim 1, wherein the processing circuitry is further configured to cause the UE to:
receive, via a first control resource set part of the plurality of parts of the control resource set and based at least in part on the wake-up signal, downlink control information indicating whether the one or more control resource set parts of the plurality of parts of the control resource set is active.

5. The UE of claim 1, wherein the processing circuitry is further configured to cause the UE to:
receive, via a first control resource set part of the plurality of parts of the control resource set and based at least in part on the wake-up signal, one or more cyclic redundancy check bits indicating whether the one or more control resource set parts of the plurality of parts of the control resource set is active.

6. The UE of claim 1, wherein the processing circuitry is further configured to cause the UE to:
receive, via a first control resource set part of the plurality of parts of the control resource set and based at least in part on the wake-up signal, a downlink control information comprising a bit indicating activation of the one or more control resource set parts of the control resource set.

7. The UE of claim 1, wherein the processing circuitry is further configured to cause the UE to:
receive the wake-up signal comprising a radio network temporary identifier (RNTI), the RNTI indicating whether the one or more control resource set parts of the control resource set comprises a grant for a downlink transmission or control information other than a downlink transmission grant.

8. The UE of claim 1, wherein presence or absence of a network temporary identifier (RNTI) in the wake-up signal indicates whether the one or more control resource set parts of the control resource set comprises a grant for a downlink transmission or control information other than a downlink transmission grant.

9. The UE of claim 1, wherein the wake-up signal is a physical downlink control channel (PDCCH) transmission, a sequence-based wake-up signal, or a low power wake-up signal.

10. The UE of claim 1, wherein the monitoring is skipped based at least in part on the wake-up signal indicating that none of the plurality of parts of the control resource set is active.

11. The UE of claim 1, wherein the monitoring is performed based at least in part on the wake-up signal indicating that at least one of the plurality of parts of the control resource set is active.

12. A network entity, comprising:
processing circuitry associated with one or more memory devices and configured to cause the network entity to:
transmit, to a user equipment (UE), configuration information indicating a plurality of parts of a control resource set and indicating to monitor a wakeup occasion for a wake-up signal, the wakeup occasion occurring prior to the control resource set;
transmit, during the wakeup occasion and based at least in part on the configuration information, the wake-up signal indicating that one or more control resource set parts of the plurality of parts of the control resource set is active; and
transmit, to the UE, at least one control message via the one or more control resource set parts of the control resource set based at least in part on the configuration information and the wake-up signal.

13. The network entity of claim 12, wherein, to transmit the wake-up signal, the processing circuitry is further configured to cause the network entity to:
transmit the wake-up signal comprising one or more bits indicating which of the plurality of parts of the control resource set is active.

14. The network entity of claim 12, wherein the processing circuitry is further configured to cause the network entity to:
transmit, via a first control resource set part of the plurality of parts of the control resource set and based at least in part on the wake-up signal, downlink control information indicating which of the plurality of parts of the control resource set is active.

15. The network entity of claim 12, wherein the processing circuitry is further configured to cause the network entity to:
transmit, via a first control resource set part of the plurality of parts of the control resource set and based at least in part on the wake-up signal, one or more cyclic redundancy check bits indicating which of the plurality of parts of the control resource set is active.

16. The network entity of claim 12, wherein the processing circuitry is further configured to cause the network entity to:
transmit, via a first control resource set part of the plurality of parts of the control resource set and based at least in part on the wake-up signal, a downlink control information comprising a bit indicating activation of the one or more control resource set parts of the control resource set.

17. The network entity of claim 12, wherein the processing circuitry is further configured to cause the network entity to:
receive the wake-up signal comprising a radio network temporary identifier (RNTI), the RNTI indicating whether the one or more control resource set parts of the control resource set comprises a grant for a downlink transmission or control information other than a downlink transmission grant.

18. The network entity of claim 12, wherein presence or absence of a network temporary identifier (RNTI) in the wake-up signal indicates whether the one or more control resource set parts of the control resource set comprises a grant for a downlink transmission or control information other than a downlink transmission grant.

19. The network entity of claim 12, wherein the wake-up signal is a physical downlink control channel (PDCCH) transmission, a sequence-based wake-up signal, or a low power wake-up signal.

20. A method for wireless communications at a user equipment (UE), comprising:
receiving, from a network entity, configuration information indicating a plurality of parts of a control resource set and indicating to monitor a wakeup occasion for a wake-up signal, the wakeup occasion occurring prior to the control resource set;
receiving, during the wakeup occasion and based at least in part on the configuration information, the wake-up signal indicating whether one or more control resource set parts of the plurality of parts of the control resource set is active; and
monitoring, or skipping monitoring of, the one or more control resource set parts of the control resource set based at least in part on the configuration information and the wake-up signal.

21. The method of claim 20, comprising:
monitoring for data transmission within the one or more control resource set parts of the plurality of parts of the control resource set based at least in part on the wake-up signal indicating the one or more control resource set parts of the plurality of parts of the control resource set to be inactive.

22. The method of claim 20, wherein receiving the wake-up signal comprises:
receiving the wake-up signal comprising one or more bits indicating whether the one or more control resource set parts of the plurality of parts of the control resource set is active.

23. The method of claim 20, comprising:
receiving, via a first control resource set part of the plurality of parts of the control resource set and based at least in part on the wake-up signal, downlink control information indicating whether the one or more control resource set parts of the plurality of parts of the control resource set is active.

24. The method of claim 20, comprising:
receiving, via a first control resource set part of the plurality of parts of the control resource set and based at least in part on the wake-up signal, one or more cyclic redundancy check bits indicating whether the one or more control resource set parts of the plurality of parts of the control resource set is active.

25. The method of claim 20, comprising:
receiving, via a first control resource set part of the plurality of parts of the control resource set and based at least in part on the wake-up signal, a downlink control information comprising a bit indicating activation of the one or more control resource set parts of the control resource set.

26. The method of claim 20, comprising:
receiving the wake-up signal comprising a radio network temporary identifier (RNTI), the RNTI indicating whether the one or more control resource set parts of the control resource set comprises a grant for a downlink transmission or control information other than a downlink transmission grant.

27. The method of claim 20, wherein presence or absence of a network temporary identifier (RNTI) in the wake-up signal indicates whether the one or more control resource set parts of the control resource set comprises a grant for a downlink transmission or control information other than a downlink transmission grant.

28. The method of claim 20, wherein the wake-up signal is a physical downlink control channel (PDCCH) transmission, a sequence-based wake-up signal, or a low power wake-up signal.

29. The method of claim 20, wherein the monitoring is skipped based at least in part on the wake-up signal indicating that none of the plurality of parts of the control resource set is active.

30. A method for wireless communications at a network entity, comprising:
transmitting, to a user equipment (UE), configuration information indicating a plurality of parts of a control resource set and indicating to monitor a wakeup occasion for a wake-up signal, the wakeup occasion occurring prior to the control resource set;
transmitting, during the wakeup occasion and based at least in part on the configuration information, the wake-up signal indicating that one or more control resource set parts of the plurality of parts of the control resource set is active; and
transmitting, to the UE, at least one control message via the one or more control resource set parts of the control resource set based at least in part on the configuration information and the wake-up signal.
